(19) United States
(12) Patent Application Publication
(10) Pub. No.: US 2009/0111082 A1
(43) Pub. Date: Apr. 30, 2009

(54) LEARNING SYSTEM

(76) Inventor: Richard Jorgensen, Chula Vista, CA (US)

Correspondence Address: LAW OFFICE OF MARK WISNOSKY, 3060 6TH AVE., # 8, SAN DIEGO, CA, 92103, US

(21) Appl. No.: 12/301,609

(22) PCT Filed: May 21, 2007
(86) PCT No.: PCT/US07/69351

§ 371 Date: Nov. 19, 2008

Related U.S. Application Data
(60) Provisional application No. 60/747,899, filed on May 22, 2006.

(51) Int. Cl. G09B 5/00; G09B 7/00

(52) U.S. Cl. 434/307 R; 434/323; 434/347; 434/327

(57) ABSTRACT

A new learning system is described. Embodiments of the learning system include an authoring system including software utilities that enable a designer to create newly effective learning material from existing content. The system further includes an infrastructure for licensing and distribution of the created learning modules that include copyright and pirating protection and license transfer. The system is based upon established theories of learning and enables the untrained designer to create an electronic learning experience that best takes advantage of these learning theories. The material has been tested and shown effective in a variety of learning and counseling situations.

### CROSS REFERENCE TO RELATED APPLICATIONS

This application claims the benefit of U.S. Provisional Patent Application 60/747,899, filed May 22, 2006, entitled, “Personal Learning Technology and Parallel Learning System and Method”, currently pending, by the same inventor, and, incorporated by reference.

### TECHNICAL FIELD

Embodiments of the invention relate to a learning system that may be designed and implemented through a personal computer.

### BACKGROUND OF THE INVENTION

The idea of using computers as teaching tools emerged very early in the history of the computer. Researchers in the 1960's were attempting to adapt the mainframe computers to be useful as a teaching and assessment tool. With the advent of the personal computer and the possibility of every student having access to their own system the developers and purveyors of educational software have created a two billion US dollar a year industry. Use of educational software is common across all grade levels and subject matter.

The situation is not however one of all success or even measurable positive effect. The US continues to lag other developed nations in basic literacy and math and science skills. A recent (2007) study by the US Department of Education evaluated the use of sixteen educational software packages used in the first, fourth, and sixth grades for reading, basic math and algebra instruction. Over 9000 students were included in the study at 45 school districts and at 140 schools. The conclusion was there was no measurable difference in the performance of students who used learning software when compared with the control groups that did not use the software. The sixteen software packages included twelve that have received or been nominated for awards by education groups, parents or teachers. After nearly 50 years of development and creation of a $2 billion dollar a year industry it is still not clear that educational software has a positive effect in the learning process.

There is room for invention.

The problem is that the software in most cases is developed either as an entertaining tool to encourage students to spend more time in study or as a drill and test tool. Neither approach is effective. Typical courses are also over-structured. Learning how to think is overlooked; courses typically only focus on what to think. There is a need for a technology based learning system that is designed around basic theories of how people learn. Dr. Howard Gardner of Harvard University has proposed a concept of multiple intelligences. There is no single generic version of intelligence. People have intelligence that is acquired and displayed along multiple vectors. The traditional perceived forms of intelligence include linguistic and logical mathematical. These are the vectors addressed by traditional schooling and most educational software packages. Reading, writing and arithmetic are the verse of traditional teaching. However there are additional forms of intelligence such as visual spatial, musical, bodily—kinesthetic, interpersonal, intrapersonal, and naturalistic. People vary in the form of intelligence that dominates. But all people have varying levels of intelligence across multiple vectors. Learning, to be effective for a large population must address these multiple vectors of intelligence. Learning to be most effective for an individual must stimulate that individual along multiple vectors of intelligence. A system is needed that addresses not just the linguistic and logic intelligences of traditional educational systems, but also addresses the musical, kinesthetic and interpersonal. A learning system is needed that addresses all of the multiple approaches to learning and intelligence.

The human brain is divided into two hemispheres. Most individuals process spatial, verbal, and factual data in the left brain hemisphere. They process intuitive, subjective, and illustrative data in the right brain hemisphere. Further, information received in the right visual field, is processed in the left-brain and information received in the left visual field is entirely processed in the right brain (Corrick, 1983). While an individual is in a receptive state, they are open to the presentation of information from a variety of sources. This would include information presented to the two hemispheres simultaneously. This receptive state is sometimes referred to as an alpha state (Pollens, 1990). There is a need for a learning system designed around the way the human brain perceives and learns. A learning system that helps to create a receptive state and that presents the information in such a way as to take maximum advantage of natural perception tendencies is needed.

Learning requires more than presentation and testing. Learning is more than memorization of facts. Learning is a change process. The learner not only acquires information, but also applies that information to new situations. Learned material is shared through conversation and other interpersonal interactions. There is a need for a learning system that goes beyond presentation and test. A learning system must create a cause and effect logic that changes the student mindset. Old facts are seen in a new cause and effect light. New facts can be fit into to this new logic. Learning creates a new intelligence to allow students to adapt and respond to new situations.

Authors, scientists, researchers and artists who excel along their own vectors of intelligence create the works in the advancement of the arts and sciences. They generally present their works to the public along those same lines. The creators of the advancements are rarely the teachers and even more rarely are they programmers preparing learning software. There is a need for a system that will take the works of the creators of the material and translate that into a form that addresses the learning modes of the individual and the population. The system should be flexible to accept work in many disciplines but rigid in molding the creative work into a learning software that addresses the multiple modes by which people learn. There is a need for a system that will allow both the authors and the educators to easily transform the creative works into a learning system without requiring them to further become computer programmers.

Distribution of the learning material in the electronic age has created new challenges. The authors and learning system creators have rights to the material and to the distribution and sale of material that can easily be abrogated through electronic copying and distribution over the Internet. Yet the ideal medium for distribution is in fact over this same Internet. Learners also want to be able to share the excitement of learning; much in the way people share books. Interpersonal intelligence is one of the learning vectors that the learning system must be addressed and the ability to share learning material with others is a means to exercise this learning vector. Therefore a learning system must further incorporate a flexible license control system that enables access to those who pay for access rights, prevents access to those who do not pay. And, further allows for controlled redistribution of the access rights from one user to another.

### SUMMARY OF THE INVENTION

A learning system is described that addresses the aforementioned needs. The system is primarily, but not completely, a computer based system that allows a non-programmer to assemble material from a wide range of sources into an electronic learning module. The learning system comprises utilities and infrastructure to create, administer and market an electronic learning module. The invention includes the overall architecture of the system, a large set of software utilities and the resulting electronic learning module itself. Although the system is flexible in the range of material that may be incorporated and therefore transformed into a learning system, it is also rigid in providing a framework that addresses the multiple intelligences and other currently accepted learning models. The system provides a structured presentation of material to create a receptive state in the learner through visual, audio and pacing control of the presentation of material. The system further provides stimulation of learning vectors by creating workbooks, feedback testing and environments for interpersonal interaction with other students and teachers. The system provides means for the student to further share the material and to complete a learning cycle by the student becoming the teacher. Learning is a change process. The described system provides an architecture, infrastructure and electronic and other material to initiate and affect a change process for the student user. It has been shown applicable to not just conventional learning situations but also in therapeutic counseling situations. The system includes software for authoring and creating a learning system, an electronic packaging system that allows for distribution and controlled licensing of the created learning system. Multiple levels of licenses are available that control the redistribution rights of the purchasers. The user interface and viewing package includes controlled access and use of the learning material but also a simulated university environment for interaction with other students in a variety of simulated environments such as a library, coffee shop, classroom, study group, and bookstore. The university includes communication through voice over Internet protocol (VoIP) to create facilities for administration, test taking, traditional lectures and other communication.

### BRIEF DESCRIPTION OF THE DRAWINGS

FIG. 1 is an overview of the general parts of the invention

FIGS. 2a and 2b depict a computer system and network in which embodiments of the invention could be practiced.

FIG. 3 is an embodiment of the invention showing example materials that may be used in the invention.

FIG. 4 presents an embodiment of the invention showing the relationship amongst design elements.

FIG. 5 represents a screen image that a designer would use in an embodiment of the invention.

FIG. 6 is a screen image from the design utilities of an embodiment of the invention.

FIG. 7 is a screen image from the design utilities of another embodiment.

FIG. 8 is a screen image showing placement of text during the design phase.

FIG. 9 is a screen image showing a preview during the design phase with text and other elements.

FIG. 10 is a screen image showing access to library files.

FIG. 11 is a screen image showing a preview utility for library files.

FIG. 12 is a screen image showing a notepad frame tracking utility of an embodiment of the invention.

FIG. 13 is a screen image showing a file list utility of an embodiment of the invention.

FIG. 14 is a screen image showing the frame splitter utility and resulting .cap file structure of an embodiment of the invention.

FIG. 15 is a block diagram showing the distribution infrastructure design and end user set-up process as used in an embodiment of the invention.

FIG. 16 is a block diagram showing the end-user set up and licensing for an embodiment of the invention.

FIG. 17 is a block diagram of the transfer process.

FIG. 18 is a block diagram showing the online university and continuing education facilities in embodiments of the invention.

FIG. 19 is a screen image showing the end-user access to the online university features of an embodiment.

FIG. 20 is a screen image showing the feedback testing utility in an embodiment of the invention.

FIG. 21 is a screen image showing another embodiment of the feedback testing utility.

FIG. 22 is a block diagram of an electronic learning module.

FIG. 23 is a screen image of a user interface to an electronic learning module.

### DETAILED DESCRIPTION

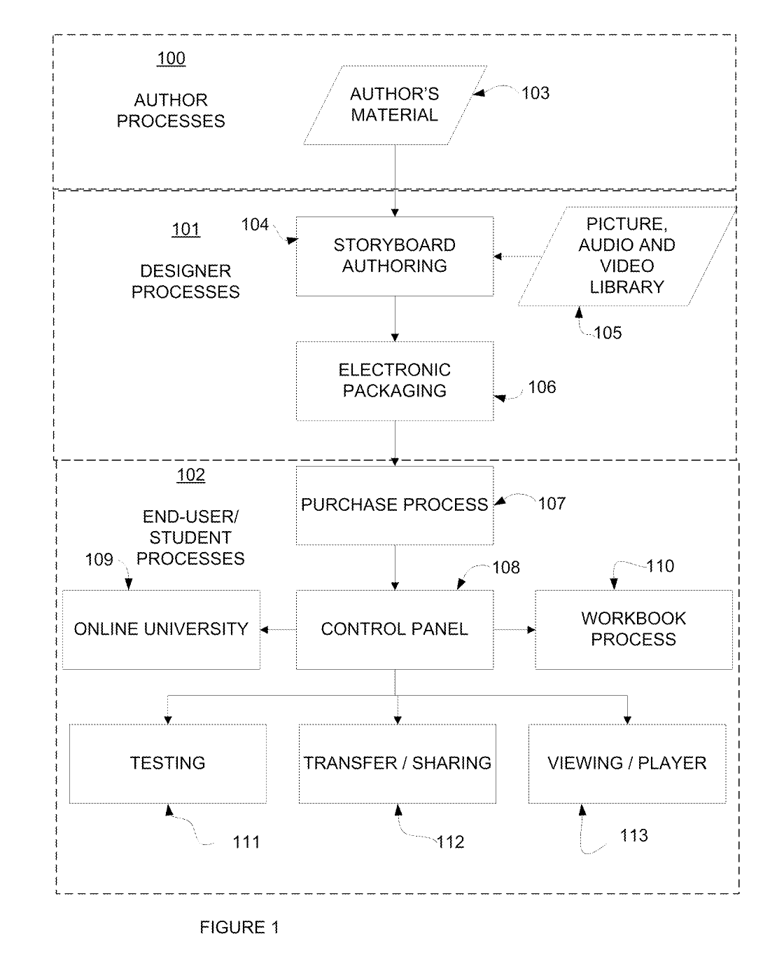

FIG. 1 depicts a high level overview of the learning system invention. Authors, trainers, educators, researchers, artists, counselors, teachers, and others have various processes 100 they use to create their material 103. This material may be in the form of books, web sites, written reports, audio files, performances captured on video, etc. The scope is very wide. Collectively the creators of original material are called authors. The authors may use tools separate from the described invention or they may use the invention itself as the creative tool to aid in the development. The output of the invention as an electronic learning module may in fact be used as the input to further refinements or uses authors' materials. Designers are often the first users of the learning system. The processes that they would use 101 are incorporated into the various embodiments of the invention and enable them to take the materials 103 and transform them into an electronic learning module through storyboard authoring 104 that combines the authors' materials 103 with library material 105 in a distinctly new way as will be seen in the discussions that follows. The learning system packages 106 this combined material into an electronic learning module that includes not just the material presented in a unique and beneficial manner but also provides a copyright and pirating protection, marketing and distribution system usable by end-user and student processes 102 to benefit from a new learning experience not available from interaction with the original authors' materials alone. A set of purchase process 107 provides means for securely identifying and licensing the student. Once licensed the student has access to a variety of processes that can be specifically customized for both the material being presented and the particular license that is purchased. Control panel software 108 is the portal through which the student accesses the system. Through the control panel a wide variety of resources may be accessed. The student is likely first to initially use personally through a viewing process 113. Additionally the electronic learning module will include several other processes and steps to support the multiple vectors of the learning process. Non-limiting examples include the online university 109, workbook processes 110, testing 111, and, transfer and sharing the resource with other students or potential students 112. The last step may involve the student as the teacher of the material now assimilated.

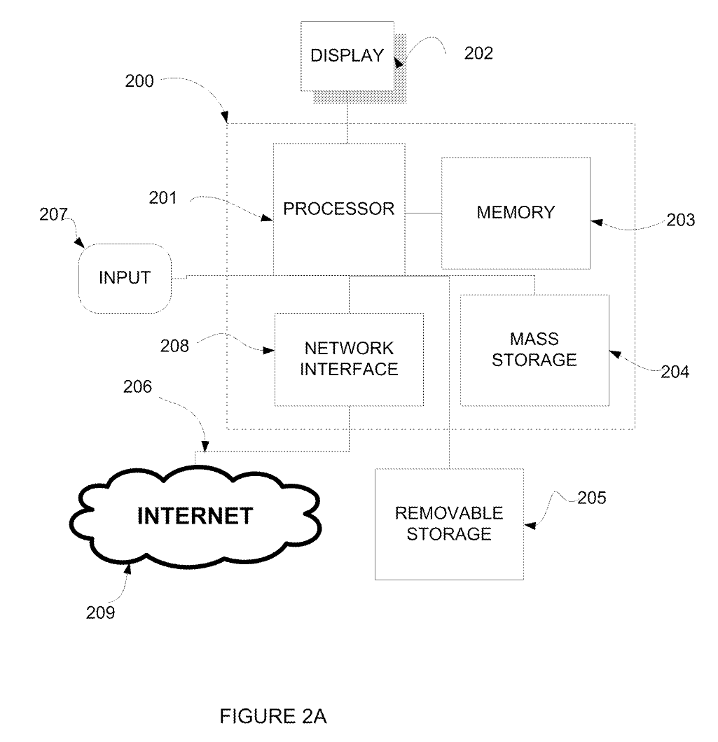

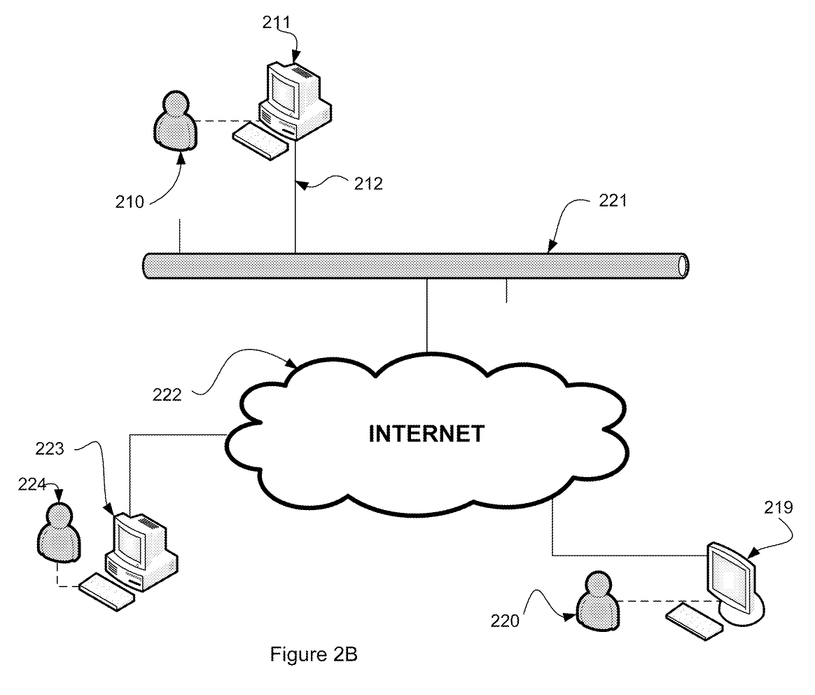

FIG. 2a depicts a typical hardware and communication environment in which various aspects of the invention may be instantiated. The computer 200 will include a user input device 207 such as a keypad or keyboard by which variously an author may create material, a designer may take that material and turn it into a learning system and a student may then access, use and share the learning system. The algorithms of the invention may be encoded in storage medium that may either be fixed memory 203 such as random access memory or read-only memory. The algorithms may also be stored on mass storage medium such as a hard disk drive 204. Similarly removable storage media 205 such as magnetic or optical disks may also contain the encoded algorithms of the invention. Whatever the storage means, it is typically connected to a processor that 201 that is able to receive and execute the encoded commands of the invention and communicate results to a local display 202. Input and output communication may also be effected remotely through for example a network interface 208 and connection 206 to the Internet 209. The connection 206 may be both wired and wireless and may be through a local network or wide are network.

FIG. 2b depicts a typical network environment in which various embodiments of the invention may be practiced. A designer 210 uses a personal computer 211 connected 212 to a local area network 221. The electronic module is created both locally on the designer's personal computer 211 as well as on remote servers 223 which the designer may access through the local area network 221 and the Internet 222. A student or end user 220 gains a license to the electronic learning module through the Internet distribution facilities of the electronic learning module. The end-user uses the learning module through their personal computer 219. The designer may also be a distributor of the electronic learning module that they have designed through use of the electronic packaging and distribution utilities. Components of the electronic learning module may reside on the server system 223, the designer's personal computer 211 and the end-users personal computer 219. Electronic packaging, licensing and access utility embodiments manage access to these distributed files through a control panel menu system that makes the files actual location transparent to the end-user.

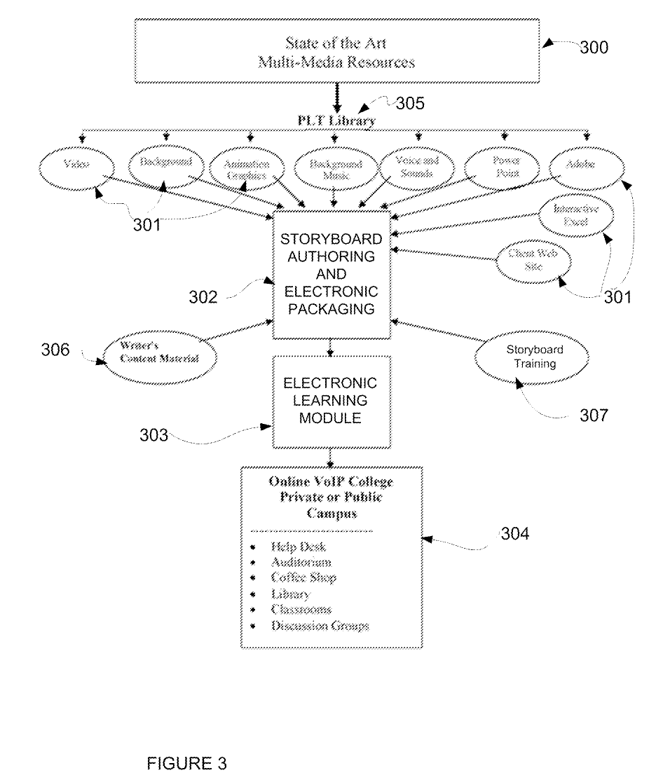

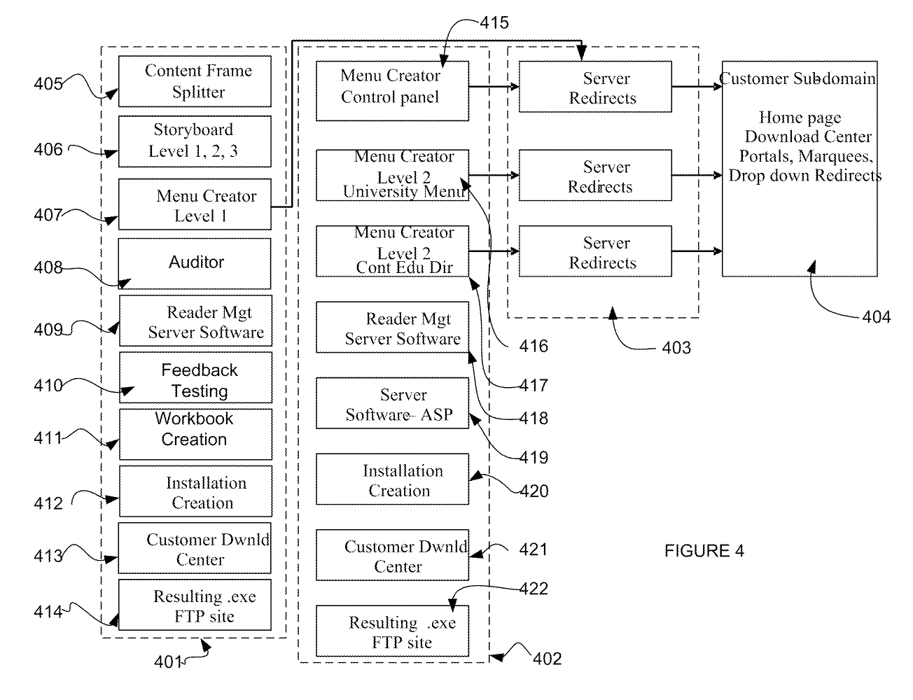

Exemplary material and the block diagram of the use of such material in various embodiments are depicted in FIG. 3. State of the art media resources 300 are combined into a personal learning technology (PLT) library 305. The utilities of storyboard authoring and electronic packaging allow designers to combine the materials of this library with writer's also called author's content material 306 and the storyboard training material and structure 307 into an electronic learning module 303. The library 305 consists of a wide variety of material 301. Non-limiting examples such as text files, image files video, backgrounds are shown. Embodiments also may include interactive and remotely distributed files such as a client web site, interactive Excel® or Adobe® files, Power Point® presentation files. The examples will give one skilled in the art an idea of the breadth of structures that may be incorporated into a learning module and are not intended as limiting examples. An embodiment of the invention further includes voice over internet protocol (VoIP) 304 that enables enhanced student interaction with authors, university and business conference centers, and content providers through simulated university, auditorium and classroom settings, with other students through online discussion groups, simulated coffee shop environments and with support through library and help desk resources. Embodiments of the system thereby provide means for human interaction as well as interaction with programmed material. A robust learning process has been found to require interpersonal and at times informal discussions, such as might occur in a classroom or coffee shop, of the course material as well as structured presentation of the course material. Embodiments of the invention uniquely provide these opportunities. Implementation of the learning system through customer website and existing infrastructure is provided in embodiments of the invention depicted in FIG. 4. The customer is typically an author, designer or other provider of learning systems to end-users. A set of routines 401 is available to the customer to combine existing content and creating new content for creating an electronic learning module that may be branded to their companies, organizations or schools. Once an electronic learning module is created, the designers further accesses utilities 402 to create a control panel that enables access to all of the features of the electronic learning module. The access to the required files is through a structured set of system redirects 403 that stream the proper file to the end-user display regardless of the files ultimate location, be it local to the end-user personal computer or located anywhere on the world wide web. The control panel includes structure to interact with simulated university setting and continuing education modules. Embodiments of the invention include multiple levels of access to the creative and organizational features for learning systems. Such levels as indicated by a level number in FIG. 4 are non-limiting examples. The redirects 403 provide added flexibility in branding the newly created custom learning system through connections to a customer sub-domain infrastructure 404. The customer sub-domain provides a branding, licensing and distribution system for content management. Redirects may also be used where copyright or other protection precludes copying of material files directly into the database of the learning system. In such cases the learning system redirects provides connection to content provided in other servers and systems. Embodiments of the learning module creating utilities 401 include a content frame splitter 405 that automatically takes written content and parses it into phrases that are of an appropriate size to be displayed in a sequence with the other content including background, video and audio files. A storyboard utility 406 combines the parsed text file with the other material into an active screen display designed to create an optimum learning experience based upon location of the text relative to the video and image files, pacing of presentation of the text and synchronization of the text with audio. A menu creator utility 407 builds a user interface for access to the file structure including links as shown through server redirects as required. An auditor utility 408 ensures that all files are actually available and the system will function as intended. Reader management server utility 409 creates the infrastructure to support the licensing requirements for distribution of the electronic learning module. Feedback testing utility 410 creates a testing process based upon the content incorporated into the storyboard presentation of the material. The testing material is optimally selected to reinforce the learning process. Material is taken directly from the storyboard presentation such that it will be familiar to the student and reinforce what has been viewed. A workbook creation utility 411 provides another means of reinforcing the learning process and accessing known learning vectors. The process creates a workbook file that when printed will provide the student end-user with hardcopy material related to the storyboard presentation. The workbook process provides a tactile connection to the learning material. End-users are expected to highlight the entire text of a printed copy of the material. This forces a review of the written material in a pace complementary to that of the storyboard presentation. An installation/creation utility 412 builds the infrastructure for the required installation of the electronic learning module on the end-users personal computer. The customer download utility 413 provides the addressing and structure to pull the required dispersed files together. A final step 414 is to create an executable file that can be run locally.

The control panel creation utilities 402 create the user interface to interact with the electronic learning module and associated features. A control panel menu creator 415 creates the top-level control panel appropriate for the features selected by the designer. In some embodiments this includes a simulated university setting or a continuing education environment. Menu creators 416, 417 respectively create the user interface appropriate for the custom features included by the designer. The Menu creator utilities 415, 416, 417 also create the pointer structure for server redirects 403 required for operation of learning module. A reader management utility 418 creates the infrastructure to manage the licensing and access to the control panel. Server software 419 provides the management of the routines between those located locally and those located remotely. The installation creation utility 420 provides the install routines for the control panel. The download utilities 421 create the routines for the customer download of the required component of the control panel system and finally utilities 422 create an executable file that will run on the end user personal computer to enable operation of the control panel to access the electronic learning module including all of the embodiments such as the viewing utility, the simulated university and others discussed above.

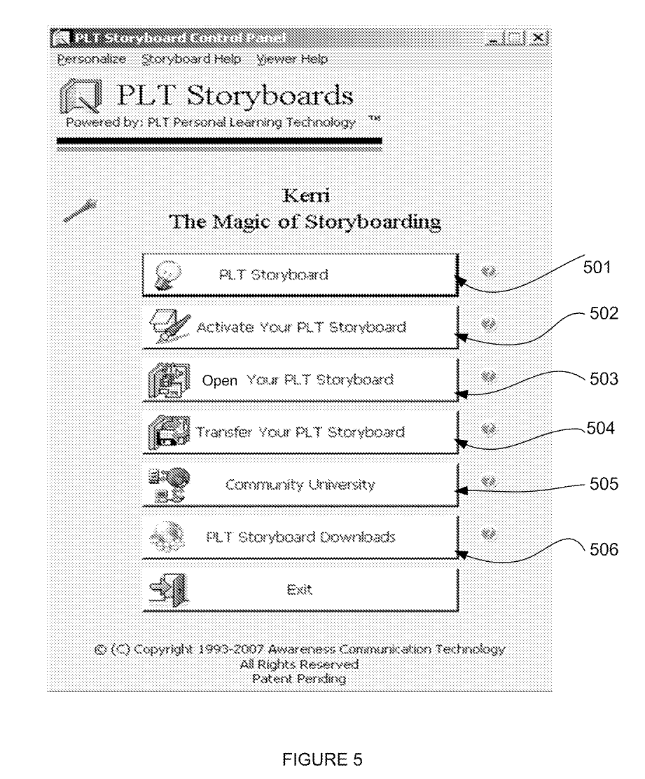

There are one to many and many to one relationships amongst the control panel and access to the electronic learning modules. In one embodiment a single control panel may be used to access multiple electronic learning modules. In another embodiment multiple control panels may access a single electronic learning module. Control panels may be customized to provide selective access to collections of electronic learning modules. The designer interface screen of an embodiment of the invention diagrammed in FIG. 4 is depicted in FIG. 5. The designer is provided, FIG. 5, access to the storyboard utilities discussed in conjunction with FIG. 4 above. The storyboard utilities may be activated 502, opened 503 and transferred to others 504. Another embodiment includes access to the simulated university environment 505 and download access 506.

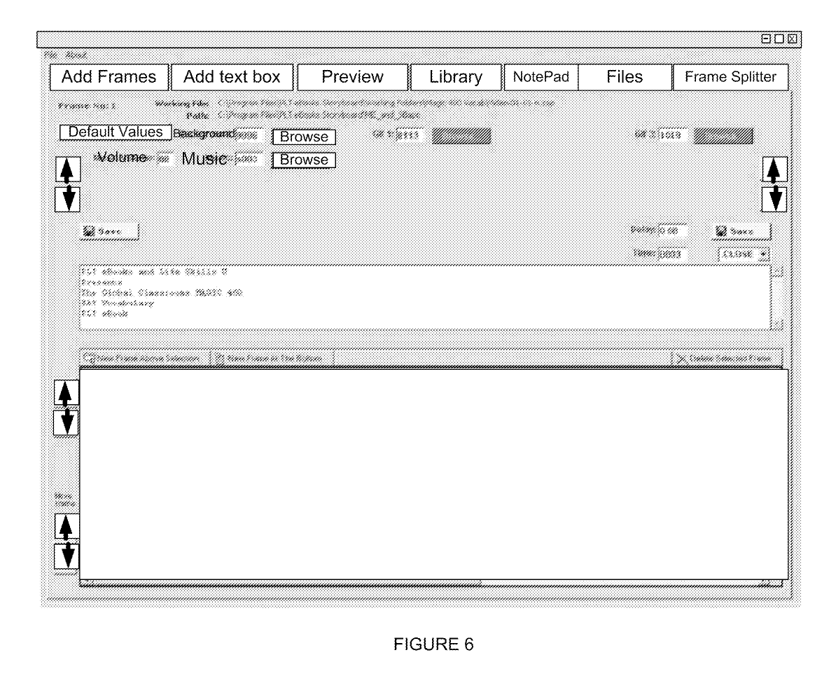

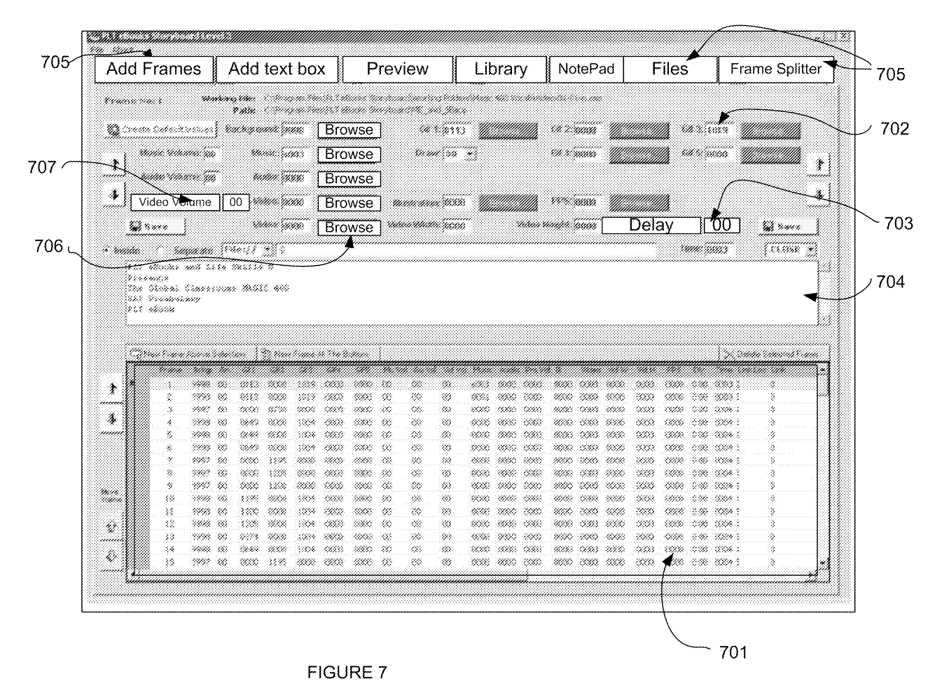

The designers create custom learning modules through design screens as depicted in FIGS. 6 and 7. As already discussed, embodiments of the invention provide access to different levels of features and design tools. FIG. 6 shows a level 1-design system.

FIG. 7 shows a design system, here designated as level 3. Selection tabs 705 choose utility areas that provides access to the basic features of file access 702 and timing for presenting files 703 and a text reference facility 704. Higher-level features may provide facilities for presenting higher numbers of graphic files simultaneously and control the parameters 706, 707 associated with presenting the graphics. The learning system presents material as a choreographed sequence of steps or frames organized for the authors in a window 701 showing particular files presented and parameters associated with those files. Graphic files are numerically identified 702 and may be selected from available databases through browsing functions 706. Summary of the current learning storyboard is provided through the detail screen 701. The authoring software provides multiple tools organized through access tabs 705.

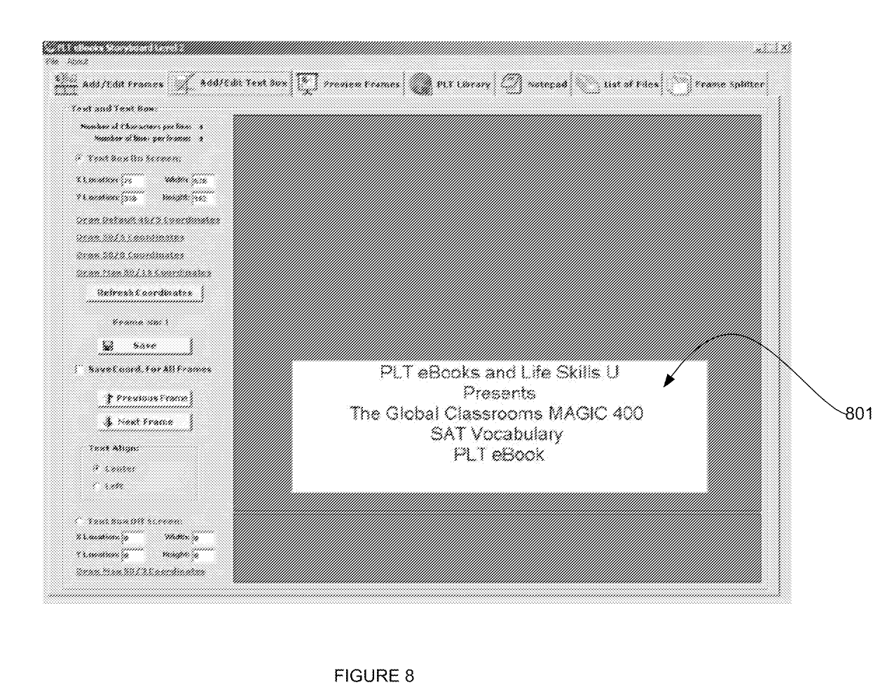

FIG. 8 is a screen image that depicts the addition of the text box tool. Text is presented 801 in the optimum screen location and in an optimum sequence of graphics synchronized with the other available elements of audio, video, backgrounds and other graphic elements.

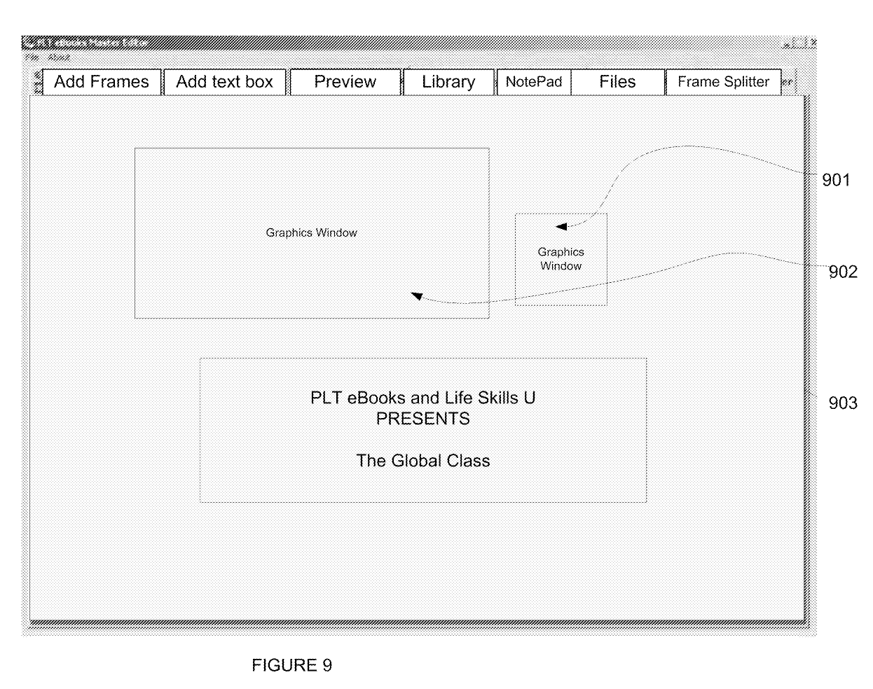

FIG. 9 is a screen image showing synchronized multiple graphics windows 901 and 902 with the text box 903. Embodiments of the invention include presentation of still images, video, audio, and any of the numerous non-limiting examples as were discussed in conjunction with FIG. 3 above. The text 903 is presented not as ASCII characters but as a sequence of graphics images as shown in the listing 701 of FIGS. 7 and 801 of FIG. 8. Presentation of synchronized text as graphics images enables language independent learning systems to be created. Characters are presented 903 as graphics images at a pace optimized for learning and synchronized with other graphic and sound presentations to maximize the student's learning. It is through such synchronized multiple graphics, audio and video systems that the multiple senses and learning skills of the student are best stimulated as discussed above in conjunction with theories of how people learn. Location of the graphics and text are also optimized for the learning experience. Text location is selected to optimize left-brain or logical learning vectors while video and graphics are placed to optimize right brain stimulation. Presentation of text, images and graphics are synchronized with music files to help create an alpha state in the end user to optimize receptiveness of the learning material. The pace of presentation is also controlled to optimize this reception. The learning system design utilities take text or other source materials and parses and combines it with other materials including images, video and audio and create a controlled application presentation file (.CAP) and an executable program that accesses a sequence of files in a controlled pace for optimized learning.

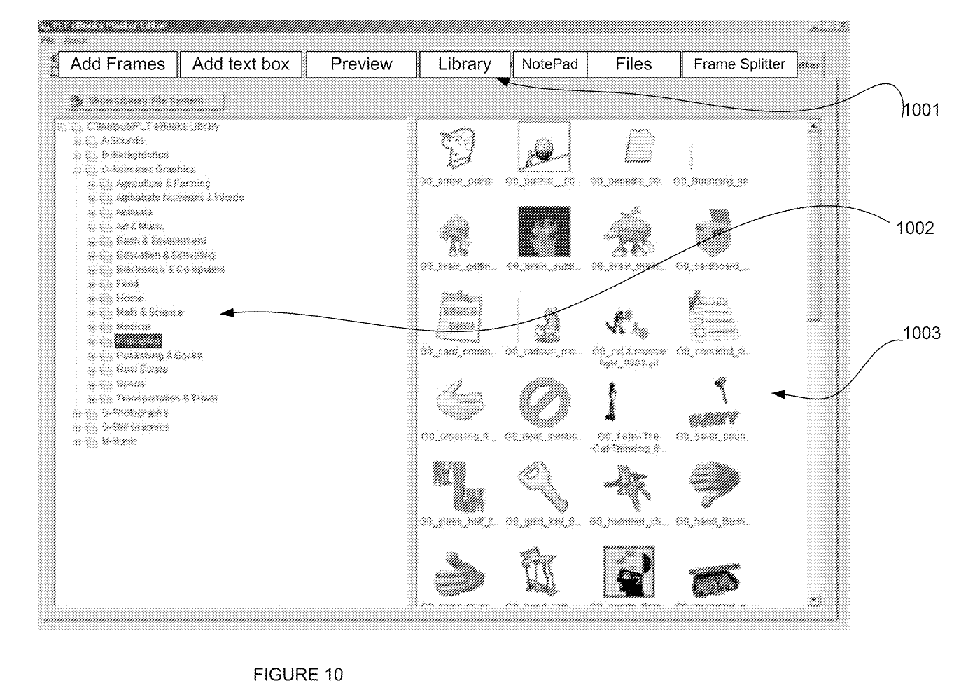

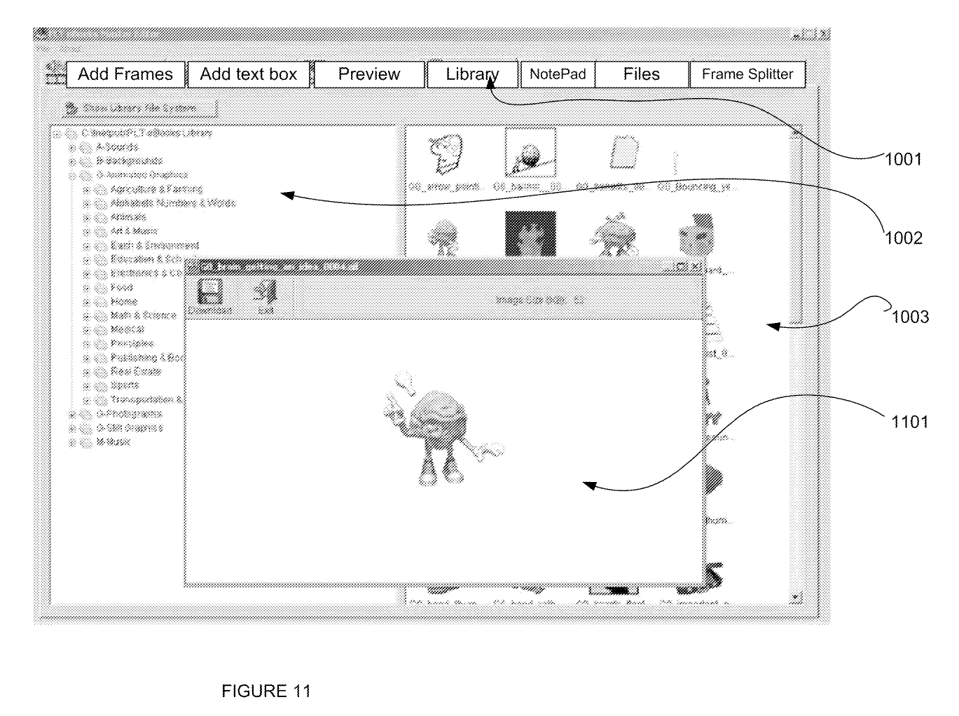

Access to the personal learning technology (PLT) library of resources is depicted in FIGS. 10 and 11. Selection of the library tab 1001 presents a file directory 1002 and icon set 1003 of resources. As discussed in conjunction with FIG. 3, icon may be representative of a wide variety of filed resources 301. Selection of a particular resource presents a preview image of the resource 1101, FIG. 11.

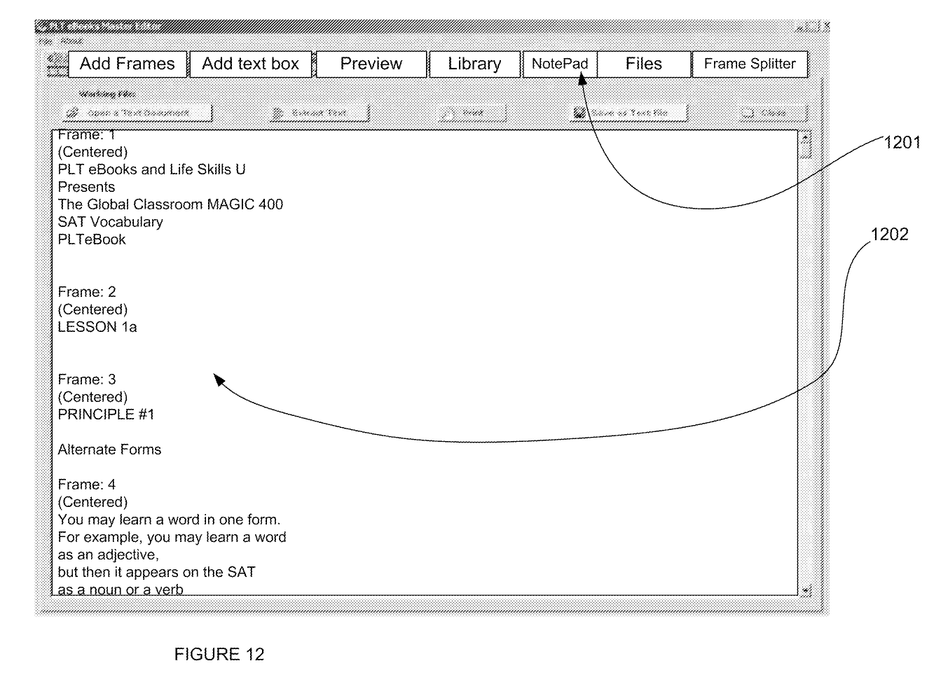

In another embodiment notepad functionality to track the contents of the series of frames that constitute the storyboard presentation to the designer is provided. FIG. 12 shows selection of the notepad tab 1201 and a window presentation of the series of frames 1202 that constitute a storyboard.

The storyboard presentation is a series of graphics images appropriately timed to present individual characters or series of characters with audio, video and other types of files. An embodiment of the invention provides utilities to manage the individual graphic files.

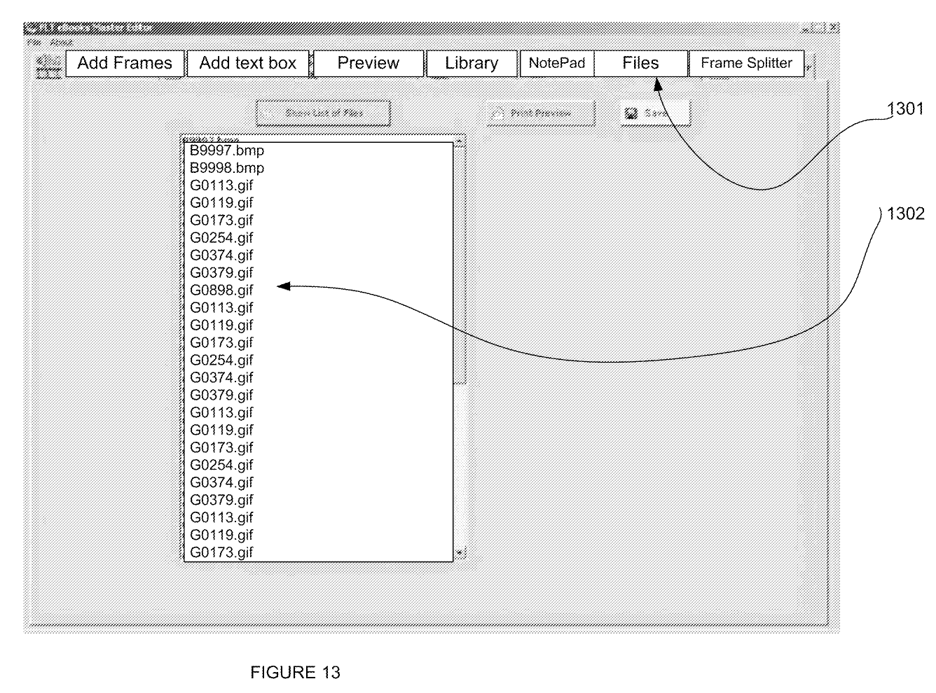

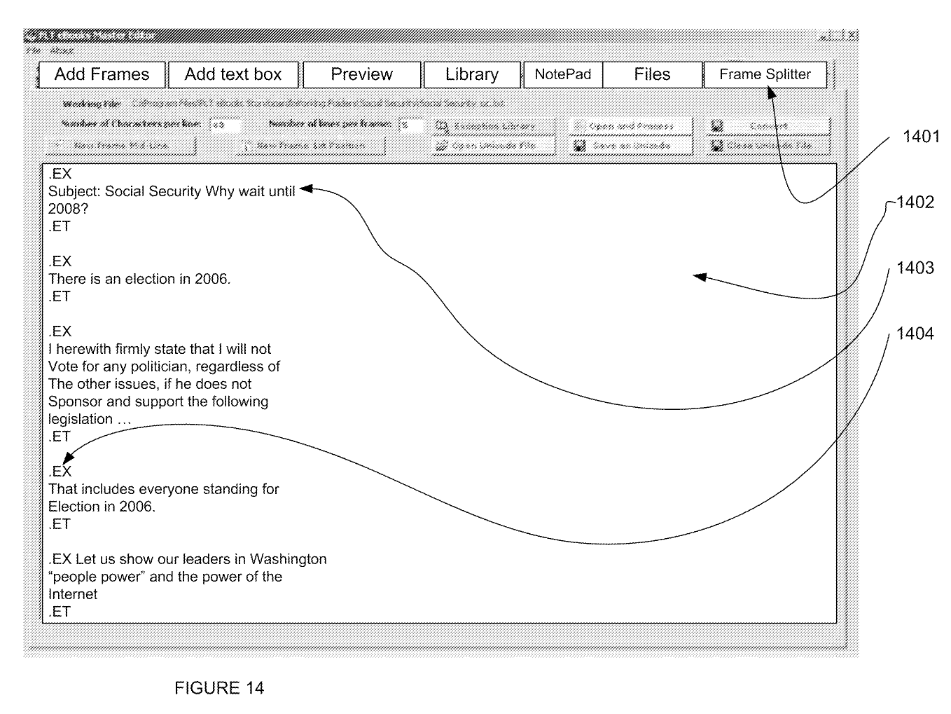

FIG. 13 is a screen image that the designer would see on selection of the list of files utility tab 1301. Individual file names are presented 1302 to track and manage content. In another embodiment, FIG. 14, a frame splitter utility is selected via a tab 1401. Results displayed in a window 1402 show resultant parsed text file content. Input text from the original creative work is automatically parsed into phrases 1403 sized according to learning theories indicators of human attention span and the ability to accept and assimilate information in reasonable sized packets. These phrases or packets 1403 are interspersed with command lines 1404 that are read by the viewing or player software and synchronizes the presentation of the individual characters of the text as graphic images with the other graphics and audio files as discussed above. The file structure shown in the display of FIG. 14 is one of several enabling embodiments that provide means to synchronize the multiple elements of the learning system to provide the enhanced student learning experience. The command lines 1404 include commands as shown along with pointers and parameters that control the display of the interspersed text, the background screen appearance, the display of image, video and audio files and the parameters associated with each of these files and display. The structure of the file is new and is given an extension of .CAP to distinguish the structure from other common file types. The viewing/player software is an interpreter of the .CAP files. For security including copyright protection the .CAP file once created is encrypted. The viewing/player software de-encrypts, interprets, executes the embedded commands and re-encrypts the file on the fly without leaving a footprint. The security of the system is therefore protected at multiple levels. Licenses are required to activate and access files. Additionally, the files that are downloaded are encrypted with security keys not related to the license. The access is secure yet transparent to the user.

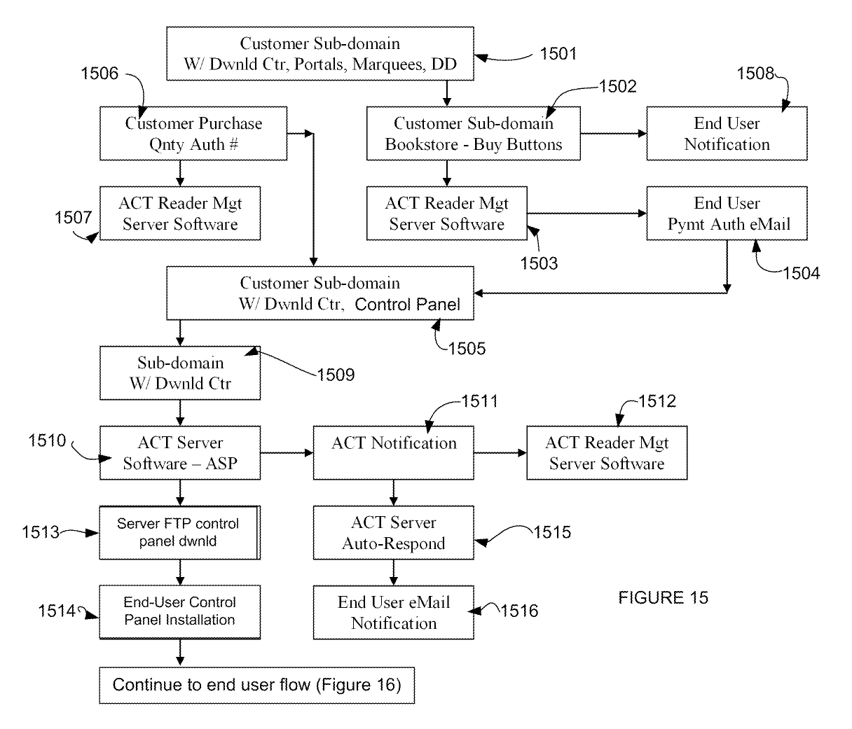

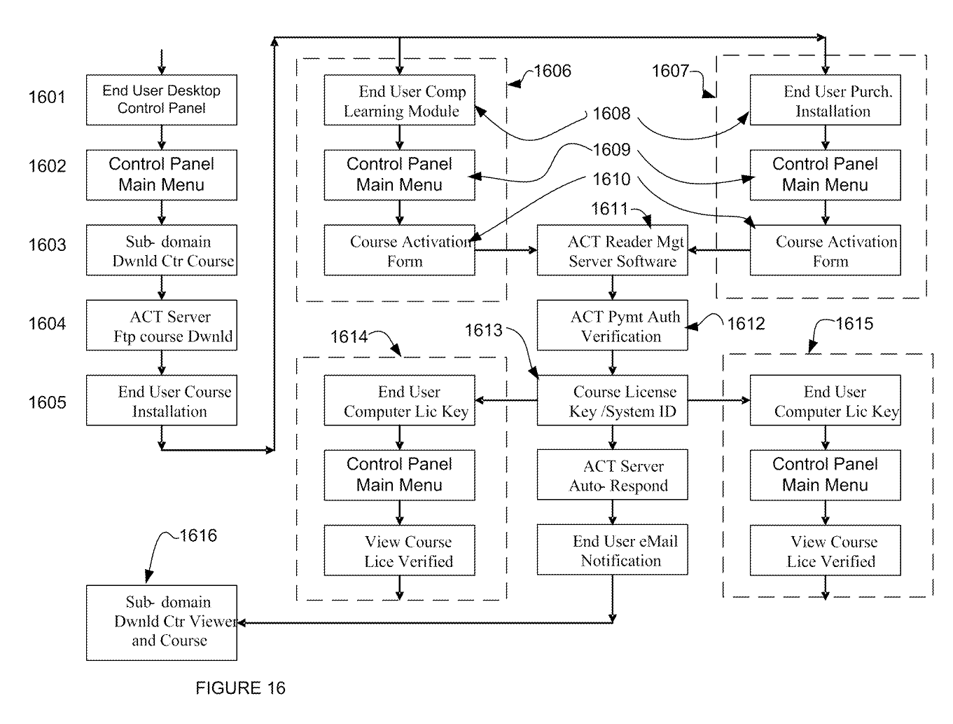

Another embodiment of the invention diagrammed in FIG. 15 enables electronic commerce of the customized learning system. License and content are distributed across multiple systems that include the service provider, the customer or distributor of the learning system and the end-user or student. A service provider will manage distribute access to the learning system design facilities. A designer may be related to the distributor or independently be developing content material that may be distributed to customers. The “customer” may be a school system, training center, publisher, business, or other entity that wants to distribute the electronic learning system material. The end user is the student who ultimately uses the learning system developed by teachers/designers and distributed by customers of the service provider. In FIG. 15 the service provider is identified as ACT or Awareness Communication Technology—a brand identity for one such service provider. The customer will likely have an established infrastructure or sub-domain 1501 unique to that customer. The structure of the learning system allows optimal use of this infrastructure through the licensing system. A customer sub-domain would have some selection means such as buy courseware buttons or menus 1502 that would both notify the purchaser of the newly purchased license and notify the infrastructure a centralized reader management software system 1503. Based upon the transmitted user information payment for a user license is authorized 1504 and notification is transmitted to the end user including a link to the sub-domain infrastructure. Alternatively, facilities with multiple licenses and users may release the service provider reader management software 1507 based upon a previously agreement between the service provider and the customer 1506 as to authorized quantity of licenses available. The end-user through access on the customer sub-domain 1505 will then have access to the download center 1509 located on the customer sub-domain. This download center interacts with the service provider server 1510 to provide notification to the end-user 1511, 1515, 1516 of installation and support material and enables end-user download of the file transfer control panel 1513 and ultimately installation of the learning software at the end-user 1514. Notification data is accumulated and stored 1512 for analysis, reporting and customer support. The process continues locally for the end-user as depicted in FIG. 16.

End-user interaction is through a control panel utility 1601. The control panel main menu 1602 allows access to the customer sub-domain 1603 which accesses the service provider server 1604 for electronic learning module download and installation on the local end-user machine 1605. Embodiments enable multiple levels of licensing and associated access and sharing rights while still using common viewing and access utilities. An end user may receive for example a complimentary electronic learning module 1606 or may purchase the electronic learning module 1607. The architecture of the system allows these exemplary multiple levels of licensing and others. The end user through either licensing path, purchases or is given a complimentary license 1608 which leads to access to the main control panel 1609. Through this control panel the user fills out an activation form 1610, which transfers license information to the reader management software 1611. After payment authorization 1612 a license key is distributed 1613 to the user locally for use of the purchased 1615 or complimentary 1614 material. In another embodiment electronic learning modules are designated as either complimentary or for purchase at the time they are designed.

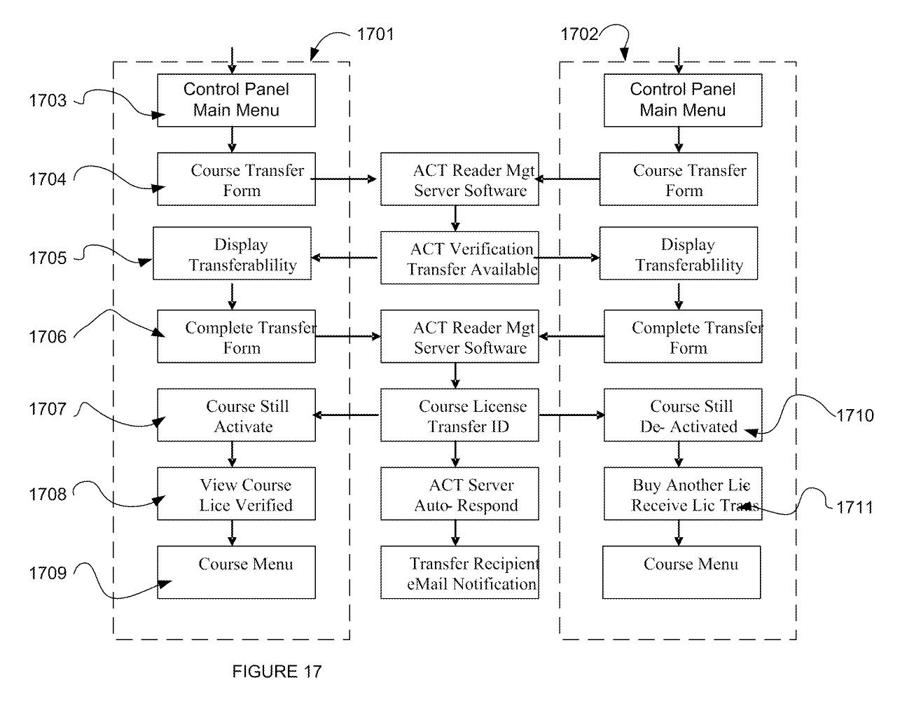

FIG. 17 further illustrates the embodiments of multi-level licensing. A user might purchase a license in which the electronic learning module material is transferable to others and the original user maintains access to the electronic learning module material. Such a license would be depicted by the scheme of 1701 in FIG. 17. Alternatively another embodiment 1702 would allow transfer, however the original license would be deactivated 1710 upon transfer. Continued use would require purchase of an additional license 1711.

The utilities for transfer start from the control panel main menu 1703. The user selects the electronic learning module to be transferred 1704 and the reader management software and the transfer verification software inform user 1705 whether the electronic learning module may be transferred. The user then fills out a electronic learning module transfer form 1706 and initiates the transfer again through the server management software and the license identification is transferred and the user is informed as to whether the electronic learning module is still activated 1707 or not 1710. Continued viewing of the electronic learning module material then proceeds 1708 through the electronic learning module menu 1709. In the case of a license with restricted transfer options continued viewing of the electronic learning module requires purchase of another license 1711.

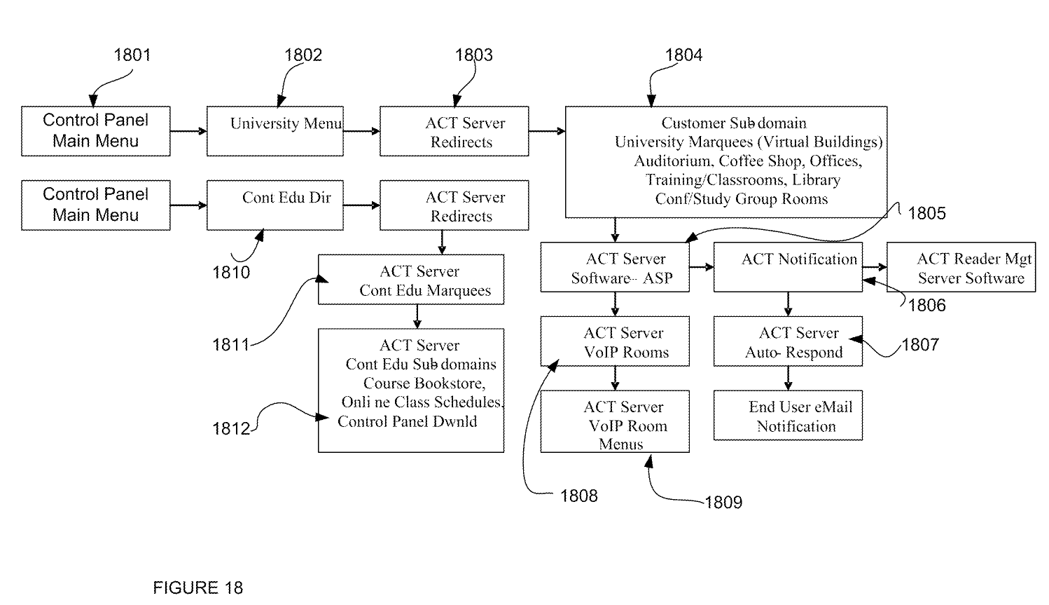

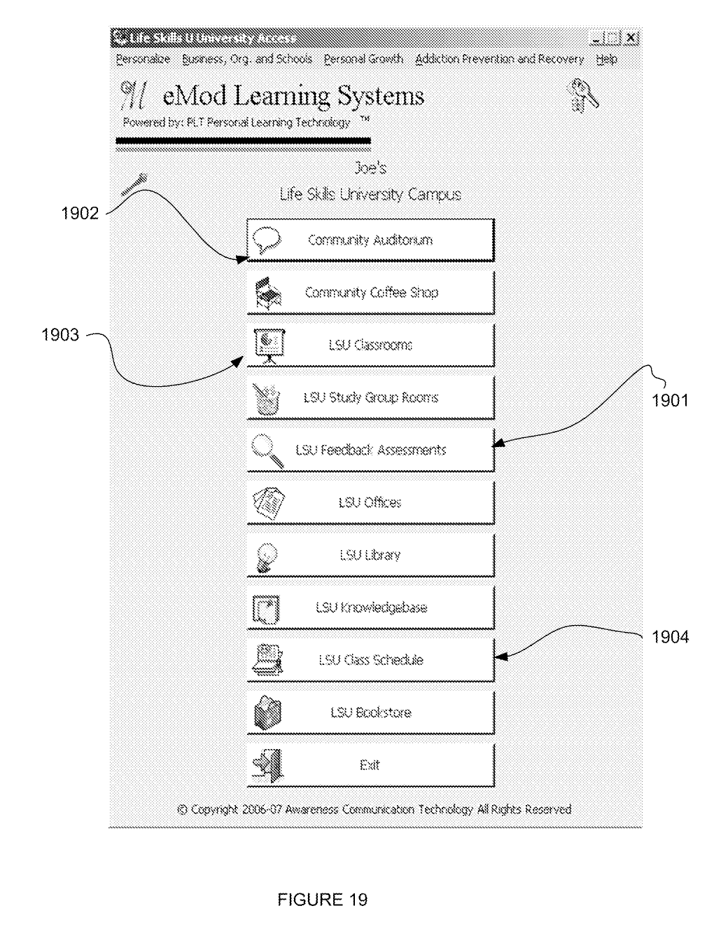

Another embodiment of the invention includes the simulated university environment and the continuing education utilities both depicted in the block diagrams of FIG. 18. From the control panel main menu 1801 the user selects access to the University menu 1802. The server redirects the request 1803 to the customer sub-domain 1804 containing the university environment. This environment has been previously created by the designer and incorporated in the electronic learning module. Note that because the university environment is part of the customer sub-domain. Each university environment may be unique to that customer environment and uniquely branded to that particular customer. The university simulation is managed through the server software 1805 that provides notification, and automatic response and notification 1807 to the end user of information and support. Once admitted non-limiting exemplary utilities available may include VoIP rooms 1808 accessible through various individual room menus 1809 to define various simulated environments further described with FIG. 19.

In another embodiment the electronic learning module is further comprised of a continuing education functionality. From the main control panel window the end user accesses the continuing education directory 1810. The functionality is administered through the service provider server that provides feedback to the user of the continuing education marquees 1811 and initiates the functionality within the customer sub-domain 1812. Non-limiting examples of the continuing education functionality include an electronic learning module bookstore, online class schedules and a control panel download to allow access to this and all electronic learning module functionality.

Embodiments of the simulated university environment are depicted in the screen image of FIG. 19. A control panel provides access to simulated facilities such as an auditorium 1902 or classroom 1903 as well as access to functional processes such as the testing and feedback processes 1901 and access to information such as a class schedule 1904.

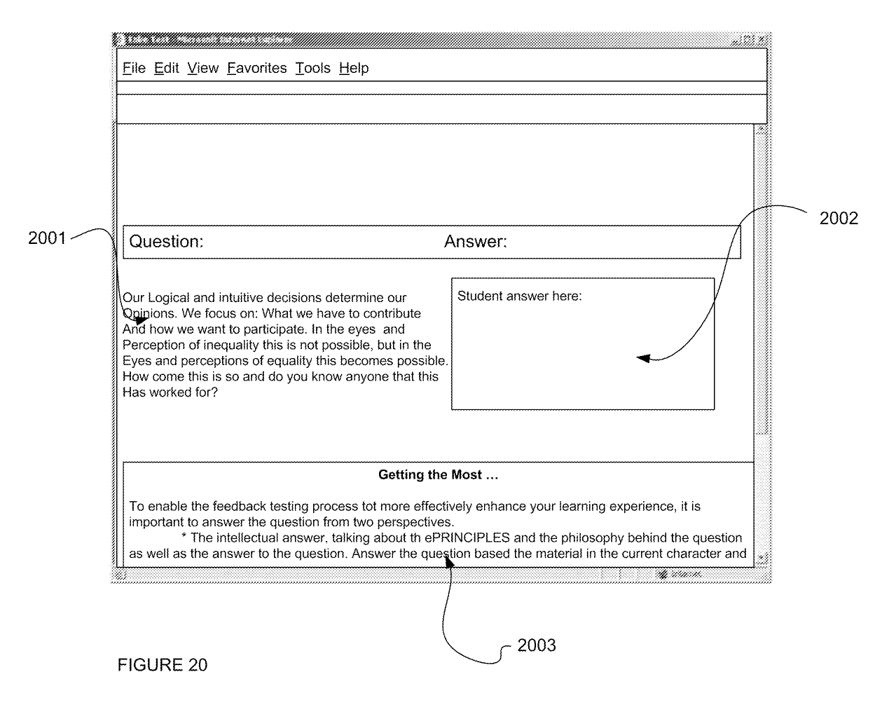

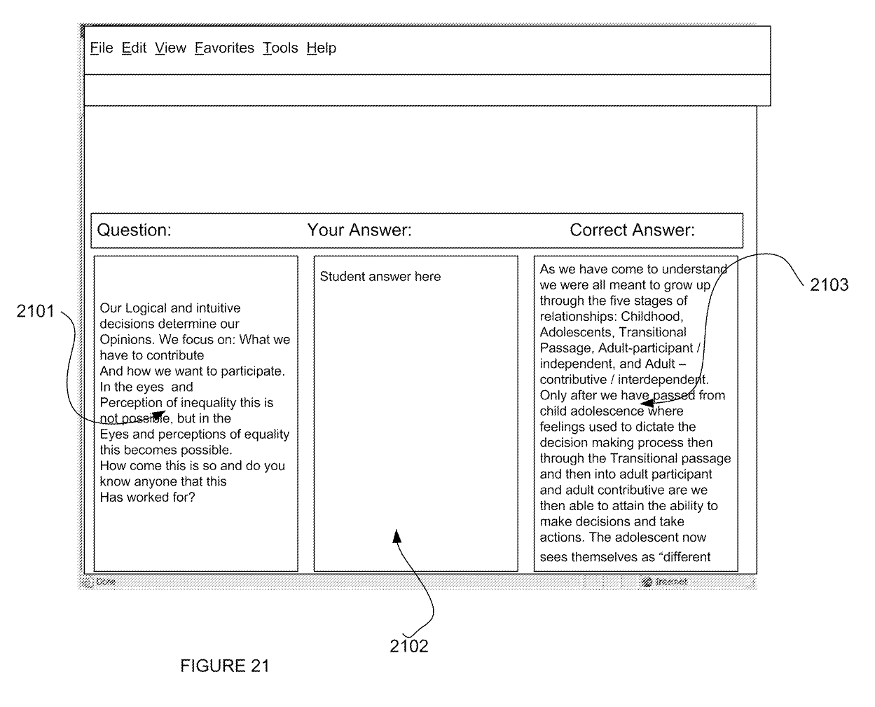

Learning is not complete without available self-testing and personal feedback on progress. Embodiments of included testing facilities are depicted in the screen image of FIG. 20. Questions 2001 are presented to the user with a response area 2002 available for the user to draft answers. Coaching is also provided 2003. Once submitted feedback is provided to the student through a screen image, FIG. 21, which may include the original question 2101, the student's answer 2102 and the correct answer 2103. Feedback is given immediately for each question to maximize the learning experience.

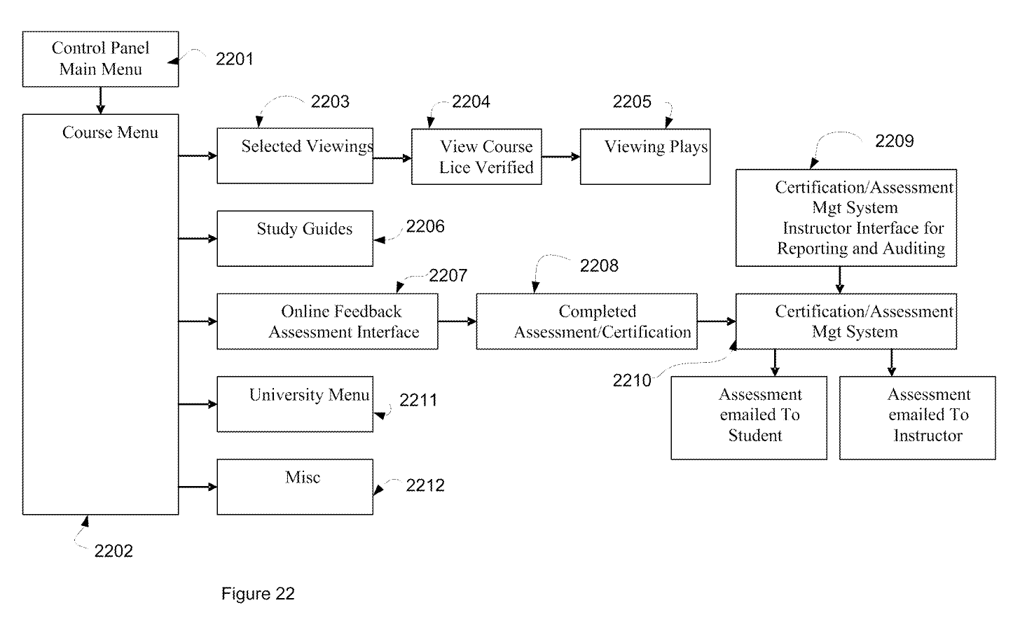

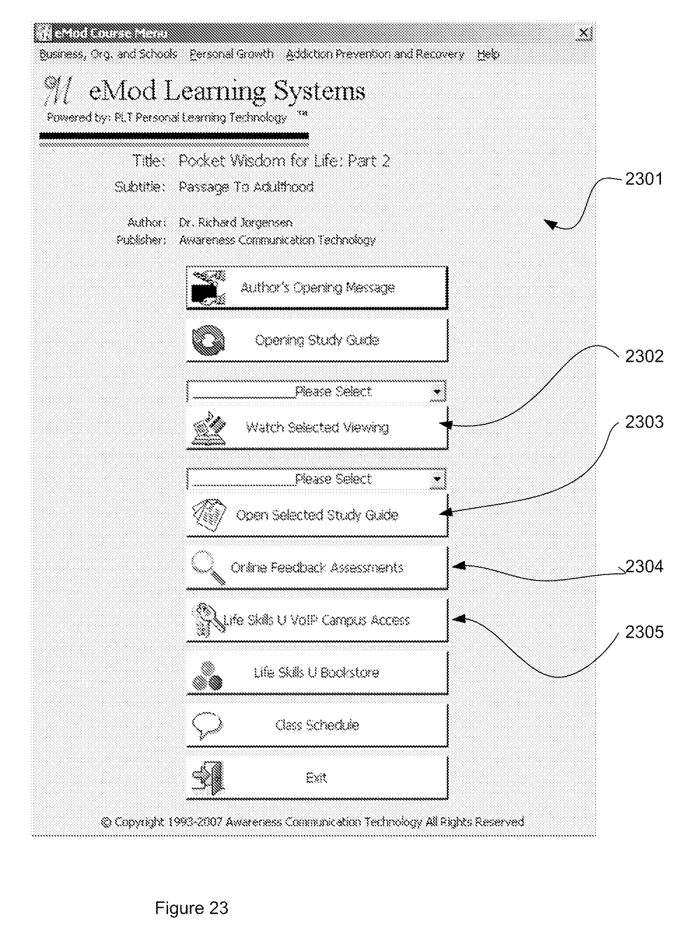

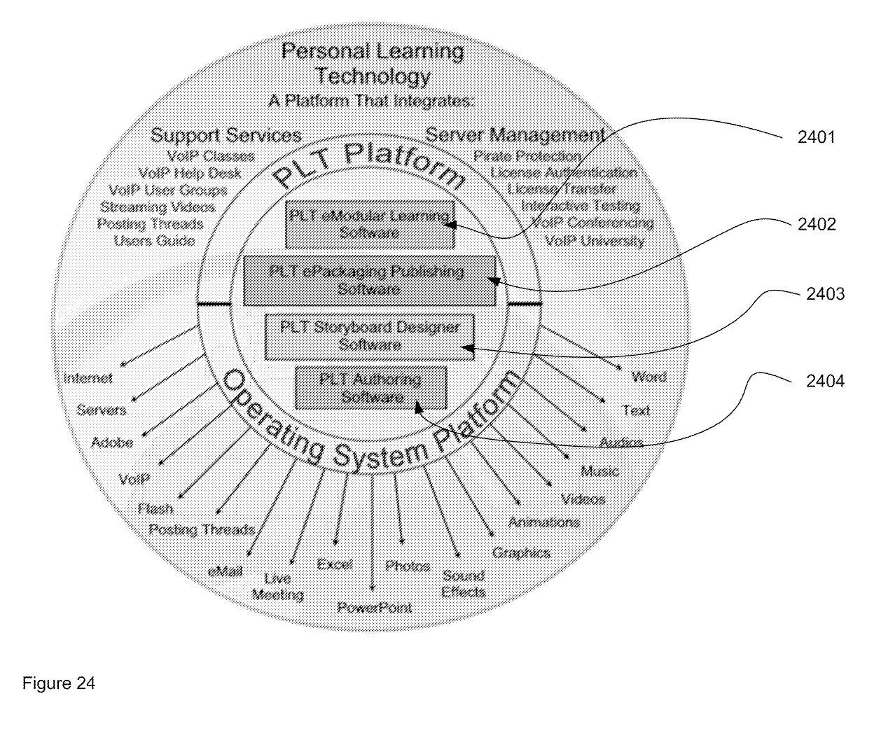

FIG. 22 depicts the block diagram for an electronic user module embodiment. The Electronic user module is created by the designer and is a main access point for the student who has purchased or been granted a license. The student accesses the module through the main control panel 2201. An electronic learning module menu 2202 will have selections for the various electronic learning module embodiments included in a particular system. The Student may select access to viewing 2203 of the electronic learning module storyboard. Once selected the student license is first verified 2204 and the storyboard is played 2205. Another embodiment of an electronic learning module includes access to study guides 2206. Selection of this embodiment provides the student access to study guides that are typically printed out and highlighted to not only reinforce the verbal linguistic learning but also stimulate the kinesthetic and other learning vectors not generally stimulated through the computer screen video imagery. Online assessment 2207 is also accessible. This may be testing and feedback as discussed above. In another embodiment the assessment includes testing for certification 2208. Another embodiment includes the assessment and certification management 2210 with accompanying communication to the student and instructor or other agent managing the assessment and certification process. The simulated university menu 2211 is also accessed through the electronic learning module 2202. Other miscellaneous 2212 features may also be included in the electronic learning module. Non-limiting examples include access to purchasing facilities such as a bookstore and access to information services such as a listing of the students' class schedule or licensed modules. FIG. 23 depicts a screen image of the control panel 2301 for an electronic learning module. The student may select a viewing option 2302 for access to a player/viewing software of storyboards created within the electronic user module. Similarly, for each electronic learning module, embodiments may include a study guide 2303 for which access is provided. The online assessment is also provided 2304. In another embodiment the on-line assessment includes a certification program and management thereof. Access to the simulated university setting is also provided 2305 through the control panel for the electronic learning module. In other embodiments miscellaneous other material may also be accessed through the electronic learning module control panel. Non-limiting examples, shown, but not numbered include a purchasing system such as a bookstore and information access such as a class schedule. A summary of the components of the learning system is shown in FIG. 24. The specific components described are the learning software 2401 to be used by a student or end-user of the material. Components previously described include the control panel for accessing electronic learning modules, simulated university environments, testing facilities and transfer capabilities. Designers use the electronic packaging software 2402 to package the control panel and electronic learning modules and other materials created through the storyboard designer software 2403 and the authoring software 2404. The system of unique components is surrounded by support and server management software to enable distribution, licensing, communication and links to services both local and remote. The learning system makes unique use of the operating system taking advantage of authoring, networking, and communication capabilities.

### EXAMPLES

A variety of material can be designed and incorporated by the described learning system into effective electronic learning modules. The procedures have been proven effective in not just traditional learning situations but also in counseling and treatment. The reason for effectiveness even in situations of learning disabilities is the design to stimulate along multiple learning vectors. Individuals unable to assimilate, learn and change through traditional learning or counseling regimes may assimilate, learn and change when new vectors of learning are stimulated through embodiments of this learning system invention.

### Example 1

A clinical psychologist had been treating a young female patient for a variety psychophysical concerns. The psychologist had used a variety of therapeutic techniques including hypnosis. An electronic learning module that taught concepts related to coping with conflict and stress was used by the patient. The psychologist found that the material was assimilated and had an effective and lasting impact on the patient. The psychologist further observed that the new material was accessible both consciously and subconsciously.

### Example 2

A clinical psychologist who provided counseling to a wide variety of clients ranging from those who are fighting addictions, to family and marriage relationship counseling to corporate intervention and team building. Electronic learning module related to principles around stress and relationships, organization culture and team building, and change processes were evaluated over a period of six months with approximately 100 patient/clients. At the end of this time the psychologist observed that use of the electronic learning module was the equivalent of eight to twelve therapeutic session intended to teach the same principles and that the learning modules seemed to penetrate defenses and overcome denials in a unique and novel fashion across the diverse set of clients/patients. The psychologist further observed a long-term exponential growth improvement.

### Example 3

A group of 84 users were tested before and after use of an electronic learning module teaching principles of personal change and self-awareness through change. The participants were selected from a battered women's shelter, recently released prison inmates and homeless unemployable men. A Rosenberg Self Esteem test was administered before and after use of the electronic learning module. The electronic modules were presented first to a small group of participants who then acted as facilitators for subsequent groups of participants. Only the initial group received the formal instruction in the material from the inventor. Participants facilitated subsequent groups. The material was presented weekly to subsequent groups over a 30-day period. Testing after the 30 day period showed statistically significant (at 95% confidence levels) increased scores immediately upon completion of the material and significantly further improvement in self-esteem assessment 90 days after use of the electronic learning module material. Learning is about change and change implies a long-term effect of the learning process.

### CONCLUSIONS

A new learning system is described. Embodiments of the learning system include an authoring system including software utilities that enable a designer to create newly effective learning material from existing content. The system further includes an infrastructure for licensing and distribution of the created learning modules that include copyright and pirating protection and license transfer. The system is based upon established theories of learning and enables the untrained designer to create an electronic learning experience that best takes advantage of these learning theories. The material has been tested and shown effective in a variety of learning and counseling situations.

I claim:

1. A learning system comprising:
a) a control panel utility to manage access to the system,
b) an authoring utility to create an electronic learning module,
c) a licensing utility that provides a license for the learning system activation,
d) a viewing utility for the electronic learning module,
e) a communication utility using voice over internet protocol,
f) a testing utility, and
g) a transfer utility between a transferor and a transferee.

2. The electronic learning system of claim 1 where the authoring utility includes means for automatically incorporating text material with electronic image, video and sound files into an electronic presentation.

3. The electronic learning system of claim 1 where the control panel allows access to a plurality of electronic learning modules.

4. The electronic learning utility of claim 1 where the licensing utility includes file encryption keys and software activation keys to activate the electronic learning module.

5. The electronic learning system of claim 1 where the communication utility includes a simulated university environment.

6. The electronic learning system of claim 1 where the testing utility includes a certification management system.

7. The electronic learning system of claim 1 where the transfer utility includes management for number of transfers and activation or deactivation of the transferor's software dependent upon the license type.

8. The electronic learning system of claim 2 where the authoring utility parses the text material into a plurality phrases and includes synchronization of the presentation of individual characters of each of the phrases with display of the image and video files and playing of the sound file to create a synchronized storyboard presentation.

9. The electronic learning system of claim 8 where the pace of the playing and the location of the graphic elements on a computer screen are optimally selected to create an alpha wave state in a the viewing user.

10. An electronic learning module comprising a controlled application presentation file and a player utility.

11. The electronic learning module of claim 10 where the presentation file comprises text information interspersed with commands, file pointers and player parameters.

12. The electronic learning module of claim 11 where the file pointers indicate file location for data files and executable files.

13. The electronic learning module of claim 10 where the player utility reads the presentation file and executes the commands.

14. The electronic learning module of claim 13 where the execution of commands includes activation of other executable files to which the file pointers point.

15. The electronic learning module of claim 10 where the presentation file is encrypted.

16. The electronic learning module of claim 15 where the player utility de-encrypts, reads, executes the commands and re-encrypts the presentation file.

17. A computer readable medium having stored thereon sequences of instructions for a learning system comprising:
a) a control panel utility to manage access to the system,
b) an authoring utility to create an electronic learning module,
c) a licensing utility that provides a license for the learning system activation,
d) a viewing utility for the electronic learning module,
e) a communication utility using voice over internet protocol,
f) a testing and certification utility, and
g) a transfer utility between a transferor and a transferee.

18. A computer readable medium having stored thereon sequences of instructions for an electronic learning module comprising a player utility and a controlled application presentation file comprising text information interspersed with commands, file pointers and player parameters.

19. The computer readable medium of claim 18 where the controlled application presentation file is encrypted.

20. The computer readable medium of claim 18 where the player utility de-encrypts, reads, executes the commands and re-encrypts the presentation file.
